(19) United States
(12) Patent Application Publication
(10) Pub. No.: US 2010/0299385 A1
(43) Pub. Date: Nov. 25, 2010

(54) METHOD & APPARATUS FOR DISPLAYING THE PRESENCE OF A SHARED CLIENT COMMUNICATION DEVICE

(76) Inventors: Timothy Root, Nashua, NH (US); Jonathan P. Steer, Nashua, NH (US); John E. Maynard, Milford, NH (US); Jeffrey T. Muller, Stow, MA (US)

Correspondence Address: ROBERT SCHULER, 45 GROTON ROAD, SHIRLEY, MA, 01464, US

(21) Appl. No.: 12/470,867

(22) Filed: May 22, 2009

(51) Int. Cl. G06F 15/16; G06F 7/04

(52) U.S. Cl. 709/202; 726/3; 709/204

(57) ABSTRACT

One or more presence capable shared or non-shared client communication devices that are members of a communications group are connected to a communications network server that is capable of receiving presence information from any of the shared or non-shared client communication devices and publishing this presence information to other member of the group. The network server maintains publication instructions that are based upon a listing of the member in the group and only publishes presence information to shared and non-shared client communication devices that are members of the group. The network server also maintains permissions rules, created a primary user of a shared client communication device, that limits access by non-primary users to the shared client communication device who are member of the communications group and that controls how the presence information is displayed in a multi-level contact directory located at either a shared or non-shared client communication device.

### FIELD OF INVENTION

The invention relates to the general area of the presence state of a device associated with a communication network and specifically to the manner in which the presence state is displayed in a contact directory.

### BACKGROUND

Communication devices, such as mobile communication or desktop communication devices, can include functionality that reports presence information to a presence service that the user can subscribe to. Presence information may include whether or not an individual associated with a particular device is “free to chat”, “busy”, “away”, “not to be disturbed” or “out to lunch” etc. Such information is often generated in association with instant messaging (IM) applications such as Google Talk IM and sent to a network server that runs a presence service. Most IM services permit individuals, who are registered to use the service, to designate particular other individual as their “friends” for purposes of notifying them of their presence and availability to communicate. In this regard, a presence service can publish presence information about any one individual member of a group of friends to all other members in the group. This individual presence information enhances the ease with which users of the messaging service, or any communication service, are able to locate friends who are available to enter into a communication session.

One class of mobile communication devices used by individuals to initiate communication sessions are referred to as non-shared client communication devices. This means that a particular individual registers a communication device with a communication or other service and this individual is always associated with the communication device, whether that individual is actually using the device or not. From the networks perspective, when the device is turned on and in a communication session, it appears that the individual who is associated with the communication device is using the device and is “present”. Lap-top and desk-top computers can also be included in the non-shared client class of communication devices. Although both lap-top and desk-top computers can be shared among several users, separate user profiles are typically created on the client communication application for each of the multiple users. In this manner, each user is able to communicate in a “private” manner with others. Once a user profile is created, the individual associated with the profile can gain access to the communication application to send messages, which are typically not “real time” messages to other individuals with access to a communication device with similar capabilities. When the communication device is turned on and in a communication session, the communication device will generate individual specific presence information according to which communication application profile is active at that time. So, from the networks perspective it appears that a particular individual is using the communication device and may be available to enter into a communication session.

Mobile, robotic devices are another class of communication device that can be connected to a communication network and which can be shared among two or more individual users. Such mobile, robotic devices can include a shared client communication application which enables/facilitates use of the robotic device by multiple individuals to communicate in various ways with others connected to the communication network. Unlike the non-shared client communication devices described earlier, separate user profiles are not created in the shared client communication application for each user of the device. Such a shared client arrangement is convenient in a mobile, robotic device to the extent that incoming calls can be received by anyone within physical proximity to the device. In this way, the robotic device behaves much like a phone. In contrast to a non-shared client communication device, when a shared client communication device is turned on and in a communication session, it does not generate presence information that distinguished among the multiple shared users. So from the perspective of the network or other members of a group associated with the shared client communication device, it is only known that “someone” among multiple individuals are currently using the shared client communications device and that “someone” is present.

Instant or real-time messaging applications (IM) are available that run on communication devices which may be shared or not. One of the advantages of such communication applications is that one individual, who is a member of a group of individuals, is quickly and easily able to determine that another individual, who is also a member of this group, is available or “present” to enter into a real-time communication session or IM session. This “presence” functionality is typically implemented in an IM client that generally operates to notify member of a group of the “presence” of other members of the group.

Typically, presence information relating to any one individual who is a member of a group can be displayed in some manner in a client communication application located in a communication device used by other members of the same group. In such cases, the presence information can appear as a graphical symbol illustrating the availability of another member of the group to enter into a communication session. In the case where multiple individuals have created separate user profiles on the same non-shared client communication device, a separate instance or presence symbol will be displayed in the non-shared client applications located in communication devices used by other members in the group. However, the manner in which the presence information generated by the shared client communication device is displayed in client communication applications associated with members becomes problematical. For example, assume that a contact listing maintained by each of the client communication devices, both shared and non-shared, includes the names and contact information (including presence information) associated with all members of a group and that the group can include a plurality of members. Further, also assume that a first member and a second member of the group are associated with the same shared client communication device. In this case, presence information generated by the shared client communication device can be displayed twice in each of the communication contact listing of every member of the group. The presence information can appear a first time under the first members contact information and a second time under the second members contact information, both of which members contact information is displayed in contact listings of each member of the group. This redundant displaying of the shared client presence information provides no additional information regarding the presence of the first or second members with respect to the shared client device, as the network is agnostic with respect to whether or not the first of second member is actually using the shared client device. In other words, the presence service does not discriminate between which of the two individuals with access to the shared client device is actually using the device, the network only knows that the shared client device is in use and therefore has a presence on the network. So, including this presence information more than once in any contact listing associated with either a non-shared or the shared device is merely redundant information and not necessary.

### SUMMARY

In a network that includes both shared and non-shared client devices both of which are capable of generating and displaying presence information, the redundant display of presence information is resolved with the creation of predetermined permission rules governing access by non-primary users to the shared client and which permit the presence information to be displayed at different levels and locations in a multiple level contact directory or listing structure. According to one embodiment of the invention, a method of displaying presence information in a contact listing associated with a plurality of shared and non-shared client devices is comprised of at least one of the plurality of the shared client devices generating presence information and sending the presence information to a presence service; the presence service publishing the presence information to selected ones of the plurality of the shared and non-shared client devices that are members of a group according to a publication map; and the selected ones of the plurality of the shared and non-shared client devices receiving the published presence information and displaying the presence information in a multi-level contact directory of a least one of the selected ones of the plurality of the shared and non-shared client devices according to a set of permission rules.

According to another embodiment of the invention, a method of displaying presence information in a contact listing associated with a plurality of non-shared client devices is comprised of at least one of a shared client device generating presence information and sending the presence information to a presence service; the presence service publishing the presence information to selected ones of the plurality of the non-shared client devices that are members of a group according to a publication map; and the selected ones of the plurality of the non-shared client devices receiving the published presence information and displaying the presence information in a multi-level contact directory of at least one of the selected ones of the plurality of the non-shared client devices according to a set of permission rules.

### BRIEF DESCRIPTION OF THE DRAWINGS

FIG. 1 is a diagram of a communications network that can support the management of presence information generated by a shared communication device.

FIG. 2 is a diagram showing the functional blocks necessary to manage presence information at a network server.

FIG. 3 is a diagram showing the assignment of permissions of owners and friends with respect to access to a shared communication device.

FIG. 4 is a diagram showing the functionality employed at a shared communications device to support the generation of presence information.

FIG. 5 is a diagram showing the functionality included at a non-shared communication device to support the display of presence information.

FIG. 6 is a diagram showing a directory format employed to display presence information for a shared communication device.

FIG. 7A and 7B is a logical flow diagram of the preferred embodiment of the invention.

### DETAILED DESCRIPTION

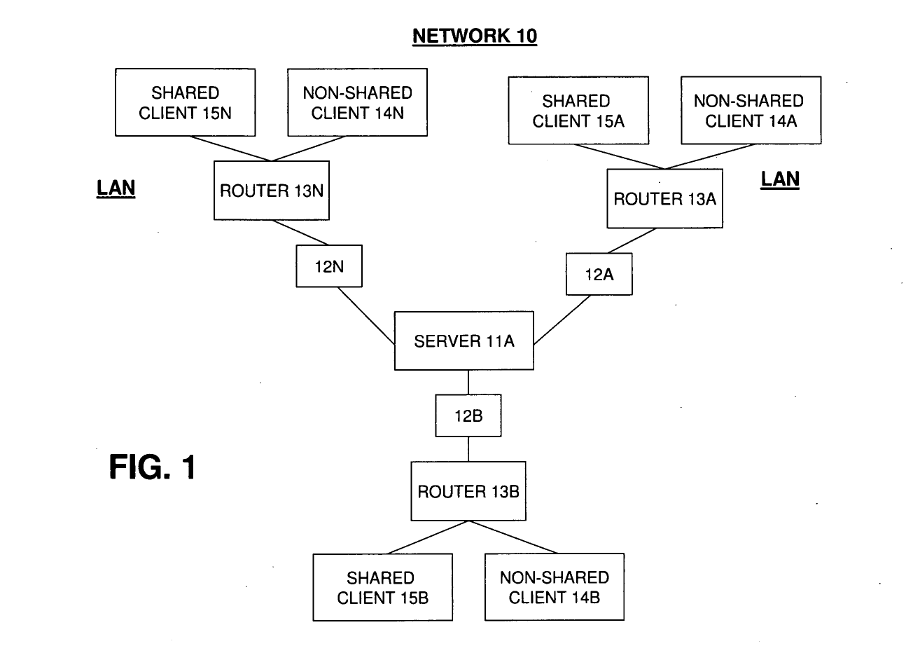

FIG. 1 is a high level diagram of a communications network architecture 10 that includes infrastructure devices and associated services to support communication sessions between end-point communication devices and to support the management of presence information that it receives from the end-point communication devices. The transmission of audio, video or other information between the end-points and the network 10 infrastructure devices can be based upon the well known Internet Protocol (IP) or any other communications protocol either non-proprietary or proprietary. The end-point communication devices can be non-shared client communication devices such as a smart phone or a lap-top or desk-top computer or they can be shared client communication devices such as a mobile robotic device or any other device that can be connected to the network 10 for the purpose of conduction a communication session. Network 10 includes a server 11A that is in communication with a plurality of intermediate network transmission devices 12A, 12B and 12N (“N” representing some integer) which are in turn in communication with routers 13A, 13B and 13N respectively. The routers 13A-N are typically local to and in either wired or wireless communication with non-shared client communication devices, or simply non-shared client devices 14A-N, which can include one or more non-shared client communication applications. The routers 13A-N are also typically in wireless communication with shared client communication devices 15A-N which implement a shared communication client and will be referred to hereinafter as a shared client device.

Continuing to refer to FIG. 1, the server 11A generally operates to support the registration of the non-shared client devices 14A to 14N and the shred client devices 15A to 15N, it operates to support an associate process between individual users and the shared client devices (15A-N), it operates to set up and support communication sessions between the communication devices and it operates to support a presence service. Registration of both classes of the communication devices with the server 11A is necessary in order for the individual users of these communications devices to take advantage of the communication and presence services supported by the server 11A. The server 11A also includes functionality that supports instant messaging (IM), audio and video communication sessions between the end-point communication devices and it includes presence service functionality also in support of the IM, audio and video communication session functionality included at the end-point communication devices. The intermediate network transmission devices 12A to 12N represent any of a number of different classes of communication network infrastructure devices that serve to, among other things, propagate communication information across the network 10. The routers 13A-N, are typically positioned in the network 10 local to both classes of the communication devices so that these communication devices can be either in wired or in wireless communication with the routers. So, for instance, each of the routers 13A-N can be located within a private residence and the communication devices associated with each router can be in either wired or wireless communication with them. Generally, the combination of the routers 13A-N, and both classes of the communication devices are in a local area network (LAN) arrangement with communication between them being implemented using either Ethernet based technology or 802.11 based technology depending upon whether the link is wired or wireless respectively.

Continuing to refer to FIG. 1, at the time of purchase (or at the time of manufacture), any of the shared client devices 15A-N can be assigned a logical network address (IP address), so that the device can be identified as a node on the network 10 in order that information can be received from and sent to the device over the network 10. Each of the non-shared communication devices (14A-N) and shared client communication devices 15A-N includes a single, IM communication application and can include an audio and/or video application as well. The IM, audio and video communication applications included in both the non-shared and shared client devices, 14A-N and 15A-N respectively, include functionality that generates presence information for transmission to the server 11A. At the time that a shared client device is turned on and connected to a LAN, it will register its IP address with the server 11A. Server 11A will then store the shared client device's IP address, and possibly some other information such as model number, software version information, capabilities, and serial number, for instance, for use at a later time when an individual logs onto the server 11A to become associated with the shared client communication device. Once the shared client device is registered with the server or the services provided by the server 11A, anyone in physical proximity to the shared client device can use it to communicate with other shared or non-shared client devices under the control of other, remote individuals. There is no limitation with respect to which how many individuals use the shared client device to communicate with others. The only limitation is that these individuals be physically proximate to the device.

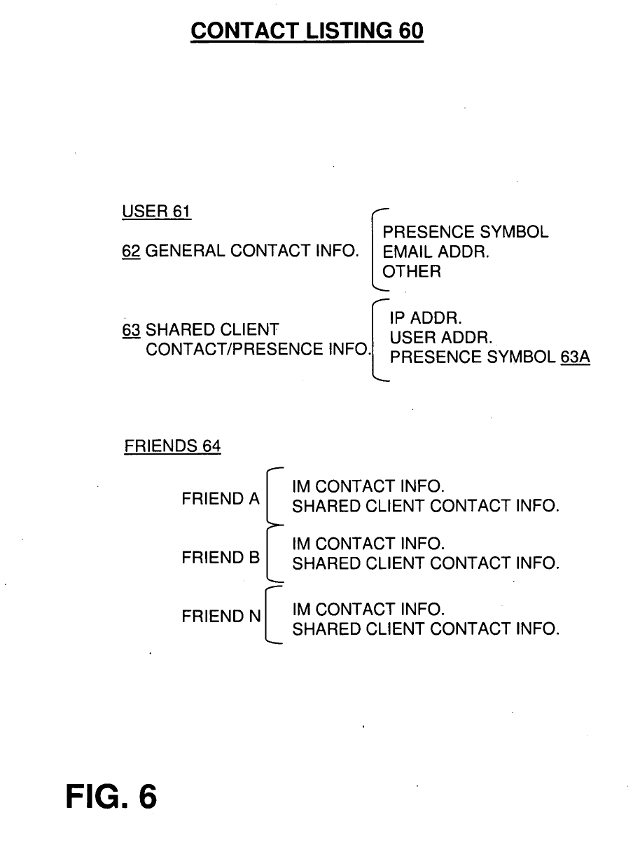

With continued reference to FIG. 1, a non-shared client device or a shared client device can be used to attempt to contact an individual with access to a shared client device. This activity results in the shared or non-shared client device generating presence information which is sent to an IM service on the server 11A. The server 11A can typically broadcast the presence information associated with the shared or non-shared client device to all other individuals who are members of a group that includes the device that generates the presence information. However, and according to one embodiment, not all members of the group may be permitted to receive presence information generated by a shared client device unless a primary user of the shared client device permits other members of the group some level of access to the shared client device. Further, the level of access permitted to any particular member of the group determines whether or not the published shared client device presence information will be displayed and how it will be displayed in a contact list associated with a shared or non-shared device controlled by individual members of the group. The presence information displayed in a contact list can be an indication that the shared client communication device is currently available or not available to enter into a communication session, whether the session is an audio session, video session or some other form of communication session. According to another embodiment, permission rules can be designed such that only a single instance of a graphical or textual symbol representing presence information, herein referred to as a presence symbol, generated by a shared client device is displayed in a multi-level directory structure. Each shared or non-shared client device that is a member of a group that includes the shared client device that generated the presence information can include this multi-level directory structure. As will be described later with reference to FIG. 6, only displaying one instance of the graphical presence symbol in a contact listing eliminates presence information redundancy and results in less confusion with respect to which individuals, if any, are proximate to the shared client device and willing to enter into a session.

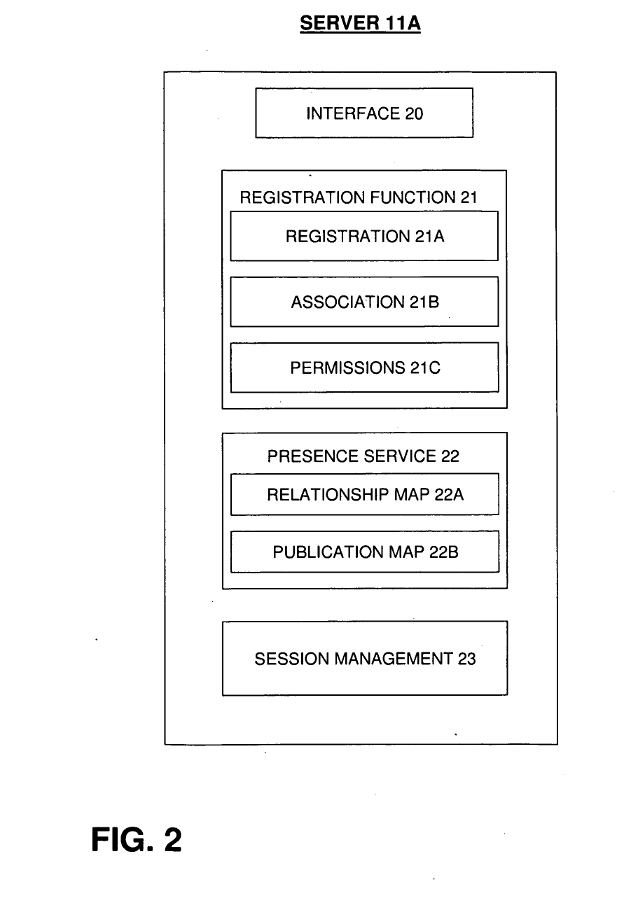

FIG. 2 is a functional block diagram of the server 11A of FIG. 1. Server 11A generally operates, as described previously with reference to FIG. 1, to support a communication device registration process, to support communication sessions between end point communication devices and to support a presence service which generally operates to monitor the presence state of communication devices registered to use the service and to broadcast presence information to registered users of the service. The server 11A includes an interface 20 to the network 10, which generally functions to transmit/receive packets of information to/from any of the communication devices (both shared client and non-shared client devices), a communication device registration function 21, which generally supports the registration of any of the shared or non-shared client communication device's with the server 11A and the association of a shared client communication device with a primary user of the device. The server 11A also includes a presence service 22, which operates to track the presence state of communication devices registered with the server 11A and to broadcast presence information to these same communication devices according to a set of permission rules mentioned previously with reference to FIG. 1. And finally, the server 11A also includes a session management module 23 (which can be either SIP or XMPP based) to support instant messaging (IM), audio and/or video or other types of communication sessions. Generally, a presence service can be designed according to the well known model for presence and instant messaging described in RFC-2778, which is a document made publically available by the Internet Engineering Task Force (IETF). In accordance with this model, the communications network 10 includes two different types of presence clients. A first type of client is typically referred to as a “presentity”. A presentity client can generate the presence information referred to above that is sent to the private server 11A and which is then broadcast by the private server 11A to a second type of client, typically referred to as a “watcher. Both of the shared and non-shared client communication devices, typically includes both a presentity and a watcher client. In operation, the presence service 22 receives presence state information from presentity clients residing on one or more shared and/or non-shared client communication devices registered with server 11A and publishes the presence information to watcher clients residing on shared or non-shared client communication devices that are registered with the server 11A. The presence state information published to each of the communication devices appears in a directory of each device and is visible to the user of the communication device as a presence symbol, which symbol can be either graphical/iconic or textual in appearance.

More specifically with reference to FIG. 2, the registration functionality 21 includes a communication device registration module 21A, a user association module 21B and a communication device permissions module 21C. The device registration module 21A operates to receive requests for registration, from both shared and non-shared client communication devices, on the server 11A. Typically, a shared client device registration request will include information that identifies one individual as the primary user of the shared client device. Once a communication device is registered with the server 11A, the server 11A can support a communication session that includes the communication device. Generally, the registration module 21A has access to a store of communication device serial numbers or some other device identification information. Each request for registration on the server 11A includes identification information specific to each communication device, this identification information is compared against the store of information, and if a match is found the registration request can be granted. In conjunction with the registration request, the IP address for each of the communication devices that are granted access to the server 11A is detected or passed in the registration request message and stored on server 11A and can be used during communication sessions to identify the location of the device for packet routing purposes. The user association module 21B generally functions to receive requests from individuals to become associated with a particular shared client device. Subsequent to a shared client device registration on the server 11A, an association request can be submitted by an individual that the server 11A recognizes as the primary user of the shared client device.

Continuing to refer to FIG. 2, the device permissions module 21C functions to provide a service that enables the primary user of a shared client communication device to create permission rules that control the type of access other individuals (secondary users and friendly users) have to the shared client device. In this regard, the permission service operates as a proxy service for the principal user of the shared client communication device. Once the principal owner of a shared client communication device is associated on the server 11A with the shared client device, they can access the permissions module 21C to set or create shared client device user permissions. Several levels of permissions can be set by the principal user, such as a secondary user permission level and a friendly user permission level to name only two levels, and permissions can be set for a plurality of individuals. For example, a primary user can designate a particular individual to be a secondary user who may be permitted unlimited or limited access to a commonly shared client device. The principal user can set permissions for this secondary user such that their access is limited during certain hours to conduct particular types of communication sessions, such as an audio or video or text only session. The primary user can also create permission rules that grant “friendly” users limited access to the shared client communication device under their control. This limited access can permit a friendly user access to a shared client device only during certain times of the day or may exclude the friendly user from receiving presence information generated by the shared client device or may limit the type of communication session the friendly user can establish with the shared client device. According to one embodiment, a multi-level contact list or contact directory structure is employed and presence information generated by a shared client device is displayed in the multi-level structure according to the permission rules described above. For clarity, it should be understood that both primary and secondary users (but not limited to only primary and secondary users) have unrestricted access to a commonly shared client device when they are physically proximate to the device (in the same room with the device), and it is only the case that a secondary user would not have access to the shared client device when they are attempting to communicate with it using a non-shared client device. In other words, when a secondary user who is not permitted access to a shared client device during particular hours is currently conducting an IM session using their non-shared client device, this secondary user might not be able to receive presence information from the shared client device, might not be able to establish an IM or other type of session with the share client device or both.

Continuing to refer to FIG. 2, the presence service 22 included in the private server 11A generally operates to receive presence information from any of the communications devices registered on the server 11A and to publish this information over the network 10 to devices/users registered on the server 11A according to a presence publication map 22A and subject to the predefined set of permission rules 21C. The presence publication map 22A is essentially a listing of individual members of a communication group, otherwise known as a buddy list, which is created and maintained by any of the individual members of the group. Normally, the presence information generated by both non-shared and shared client devices is broadcast to all members of a communication group; however, according to one embodiment, the broadcasting of presence information generated by a shared client device can be restricted according to the predefined set of permission rules as described earlier with reference to FIG. 2. For instance, in the event that a secondary user is not permitted access to a commonly shared client device during certain hours of a day, they will not receive presence information generated by the shared client device during these restricted hours or they may not be able to engage the shared client device in a session.

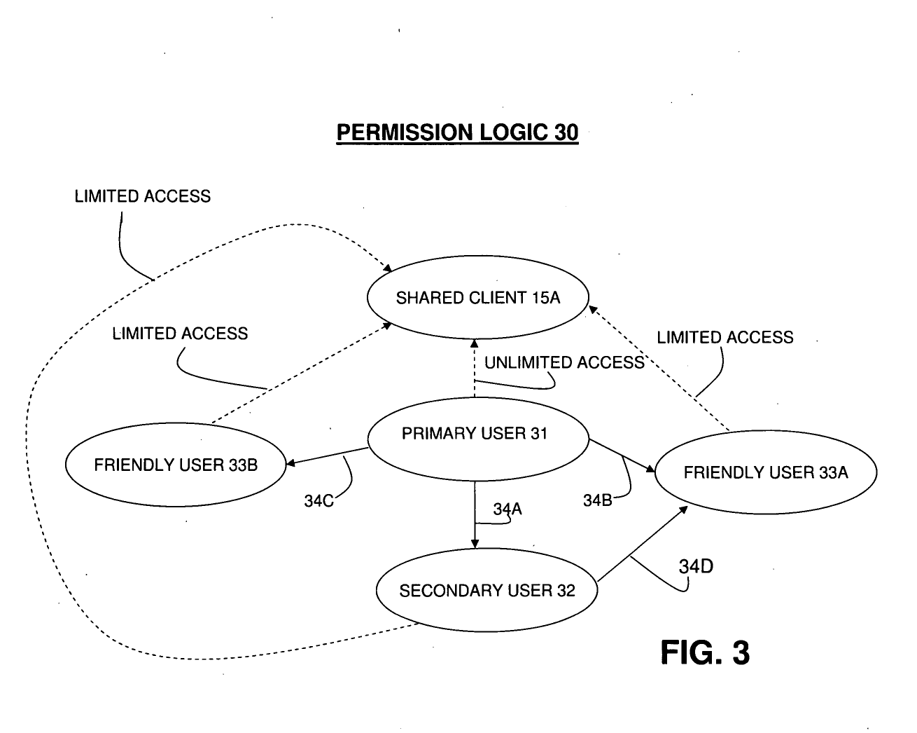

FIG. 3 is a diagram showing permission logic 30 that can be created by the primary user associated with a shared client communication device, which for the purpose of this description can be the shared communication device 15A of FIG. 1. The permission logic 30 is stored at server 11A and includes one or more (a set) of permission or proxy rules for a primary user 31, a secondary user 32, and two friendly users 33A and 33B. A permission rule defines the access each individual on the network 10 has to each of the communication devices registered on server 11A and a corresponding set of rules that are created by the primary user are maintained at the server 11A. The primary user 31 has “full” permission to access the shared client communication device 15A to initiate an audio and/or video session at any time and to set permissions for secondary and friendly users. Although not limited to the following, the primary user 31 can create a permission rule for secondary user 32 that limits the times during which the secondary user can access the shared device 15A, limits the distribution of presence information from the secondary user's 32 shared communications device 15A to friendly users and/or limits the use to audio only or limits session initiation to only a limited number of other communication devices or to particular devices. FIG. 3 shows each set of permission rules connected to another set of permission rules by a solid line with an arrow that indicates the logical direction of the permission. The permission direction is indicative of the logical relationship between an individual who created the permission profile and an individual to whom the permission is being given. So, for instance, if the primary user 31 creates a friendly permission profile for friendly user 33B, indicated by the line labeled 34C and the secondary user 32 creates a friendly permission profile for friendly user 33A which is indicated by the line labeled 34B, the permission profile that 33A extends to 34D is limited by the permission profile that 31 extends to 33A for connecting to 15A. Each permission profile is also connected to the shared client communication device 15A by a dashed line that is indicative of the access to the shared device 15A that is granted to each user. In one case, friendly user 33A is granted limited permission to “call” the shared client communication device 15A to initiate an audio and/or video communication session with the primary or secondary user of device 15A during a specified time period “X”. In another case, secondary user 32 is granted limited permission to use the shared client device 15A to initiate an audio and/or video session without any limitations on time. Finally, the permission rules described in FIG. 3 not only determine which members of a group have access to a shared client device and which members are distributed presence information generated by the shared client device, but these rules also control the level, of a multi-level contact list, at which this presence information is displayed. For example, the presence information generated by a shared client device associated with an individual granted primary user permission is displayed in the first level of the primary user's 31 contact list and presence information generated by a friendly user's shared client device who is granted limited permission to access the primary users shared client device will be displayed in the second level of the primary user's 31 contact list. Typically in the prior art, the second level of a primary user's contact list will be employed to display presence information associated with a secondary user 32, who is also member of the group. However, and according to the preferred embodiment, the shared client device presence will not be displayed here even though the secondary user 32 is currently using the shared client device. Rather, this presence information will only be displayed in the first level of the primary user's 31 contact list. In this manner, a primary user can easily observe the presence state of their shared device without the necessity of searching for this presence information in the second level of their contact list where their buddies or friends are displayed, which buddies in this case would be an individual granted secondary user permissions . Finally, it should be understood that although the preferred embodiment of the invention is described here as being comprised of a contact listing with two levels, the contact listing is not limited to only two level, but can include more than two levels.

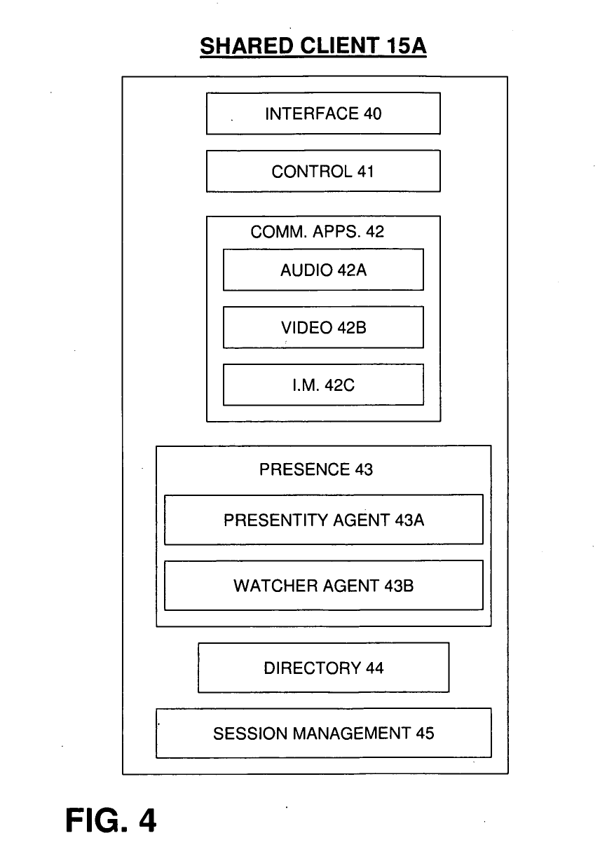

FIG. 4 is a block diagram showing the functional blocks comprising the shared client communication device 15A. The shared client communication device in the preferred embodiment is a mobile robotic device that is capable of wirelessly or wired connection to network 10 of FIG. 1 in order to participate in a communication session with any of the other non-shared or shared client communication devices registered with server 11A. The shared client device 15A includes a network interface module 40 for connecting to the wireless router 13A in FIG. 1, a robotic control module 41 for controlling, among other things, the motion of the mobile robotic device 15A in its environment, an audio and a video application 42A and 42B respectively, a presentity agent 43A and a watcher agent 43B, a multi-level directory module 44 and a session management module 45.

More specifically with reference to FIG. 4, the network interface module 40 can be a radio that operates according to the well known 802.11 wireless communication standard to transmit and receive audio, video and data information to and from the wireless router 13A of FIG. 1. The mobile robotic control module 41 generally operates to receive control information either from a remote robotic control device (can be any of the non-shared devices 14A, 14B, 14C) or from its environment and to use this information to move around its environment. Techniques for controlling robotic motion are well known to those in the field of mobile robotic devices and so will not be discussed here in any detail. The shared client communication device 15A also includes an audio communication application 42A and a video communication application 42B. The audio application 42A can be a voice over internet audio application, streaming media application, an alarm notification application, or a video recording application to name only a few. Some or all of these applications can be active during a communication session and are under control of a user of the communication device during the course of the session. The presentity client 43A generates presence state information that is transmitted to server 11A for publication to other communication devices who are members of a group and the watcher agent 43B operates to receive presence state information broadcast by the server 11A. The presence state information, received by the watcher agent 43B, is used by the multi-level directory module 44 to update the appearance of a presence symbol. This presence symbol is a visual display that represents the presence state of a shared client device and is included in a multi-level contact list maintained by any of the non-shared or shared client devices that are members of the group. Finally, the shared client device 15A includes a communication session management module 45 which operates to maintain an active communication session while the shared client device 15A is turned on and registered with the network 10 according to the well known IETF RFC3261.

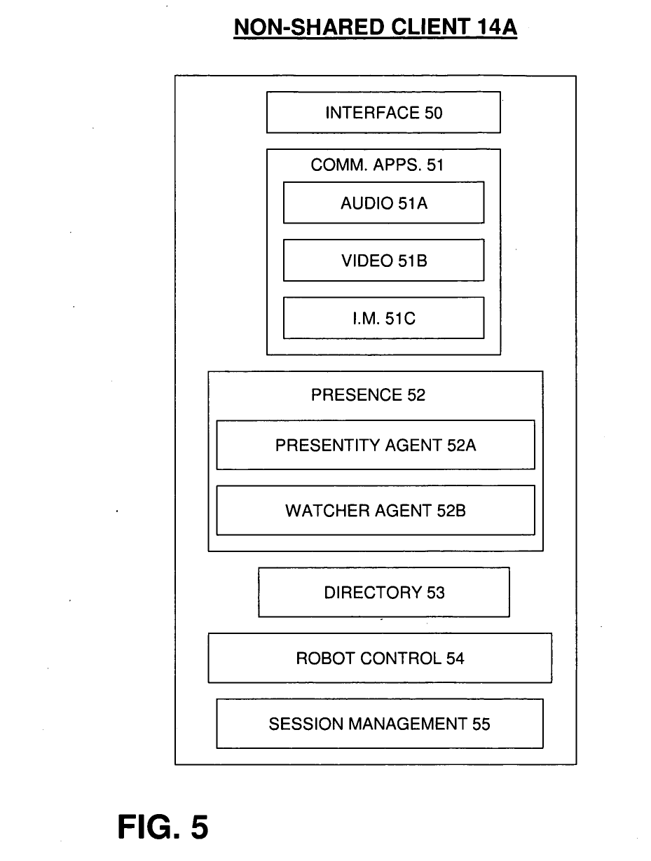

FIG. 5 is a block diagram showing the functionality that can be included in a non-shared client device, such as the device 14A of FIG. 1. The functionality that can be included in a non-shared client communication device is much the same as that which can be included in a shared client device, with the exception that the robotic movement control functionality typically operates to generate commands to be sent to a mobile robotic device where they are used to effect robot movement. Generally, the non-shared client device 14A includes a network interface 50 that is in wired or wireless communication with router 13A of FIG. 1, a communication module 51 that can include an instant messaging application 51A, an audio application 51B and a video application 51C, a presence module 52 that can include a presentity agent 52A and a watcher agent 52B, a robot movement control module 54 and a session management module 55. The network interface 50, the application included in the communication module 51, the clients in the presence module 52, the directory 54 and session management module 55 all operate in a manner similar to the corresponding functionality that is described earlier with reference to FIG. 4. Only the robot movement control module 54 operates in a manner that is different from the movement control module 41 described earlier with reference to FIG. 4. The operation of all of the functional modules described herein with reference to FIG. 5 are well known to those in the field of communications technology and so, with the exception of the operation of a multi-level directory module 53 will not be described here in any detail.

Continuing to refer to FIG. 5, the multi-level directory module 53 generally operates, in a manner similar to module 44 described with reference to FIG. 4, to manage and to maintain an up-to-date listing of a users communication contacts in a multi-level contact list. This contact list typically includes the name and contact information associated with friendly users as well as primary and second users (primary or secondary users) of the shared or non-shared client device who are a member of a group. Contact information associated with friendly users can include a device network address (device IP address), email address, IM address (others) associated with either a shared or non-shared client communication device. Contact information associated with primary and secondary users of a shared client communications device can include a device network address, email address, IM address or other communication application address. In addition to the contact information, presence state information can be included in a contact list. The presence state information can represent the current availability of a shared or non-shared client device, or user of the device, to enter into a communication session. Such presence states can also include, but are not limited to, “available” for a session or “not available” for a session, user activity such as texting status, geographic location or the mood of an individual. As described earlier with reference to FIGS. 3 and 4, the contact directory or listing is designed to have a multi-level structure as opposed to a flat contact listing. The multi-level contact listing, in the preferred embodiment, is organized in an ordered or hierarchical fashion, such that the presence information generated by the primary user of a shared or non-shared client device is displayed at the top of the listing and presence information generated by other, friendly members of a group that the primary user is associated with is displayed lower in the listing, under the presence information associated with the primary user.

FIG. 6 is a diagram showing the ordered, multi-level organization of a single instance of a contact listing or contact directory as it is displayed in either a non-shared or shared client device to a user (primary, secondary, friendly user) of the device. Contact list 60 shows a user 61, which can be either a primary or secondary user, with general contact information 62 (typically non-shared client contact and presence information) and shared client device contact information 63, which in the preferred embodiment is includes presence information generated by one or more of the principal users share client device) associated with the user's 61 communication devices and it shows contact information 64 for the friends or “buddies” of the user 61. The general contact information (email, IM, other) can be user addresses and presence state information associated with non-shared client communication devices such as a lap top, smart phone or some other personal communications device. The shared client communication device contact information 63 can include the IP address of a shared client communication device, such as the communication device 15A of FIG. 1, and it can include presence state information in the form of a presence symbol 63A that is visible to the user as shown in the directory arrangement 60 of FIG. 6. The user's 61 friendly contact information 64 can include a listing, in any selected order, of contact information for the friends of the user. This listing is shown as “Friend A”, “Friend B” and “Friend N”, with the “N” standing for some integer. The user 61 can establish a communication session with Friend A, for instance, by selecting Friend A from the listing of contact. In selecting Friend A, the directory module 53 of FIG. 5 then displays the next layer of contact information which in this case can be Friend A's non-shared client device contact information and/or their shared device contact information. Alternatively, the user 61 can select their own shared client device contact information 63 and initiate a communication session with their shared device 15A. In this case, the user 61 can establish a session with any of the other individual users who have access to the users 61 shared client device, provided that any one of the other users are available to participate in the session. Also, the user 61 can establish an audio or video session without there any individual being proximate to the shared communication device. In operation, a primary user can access a directory on their non-shared client device, such as a lap top, and select an icon or text that initiates a session with their shared client device, which can be remote from the user's location. Provided the shared client communication device is not currently participating in a communication session (as will be indicated by the presence symbol visible in the user's directory), the session will be created by a primary or secondary user (given permission) whether or not there is another user proximate to the shared client communication device. The ability to establish such a “one way” session can be advantageous if a primary or secondary user merely wants to determine who is present proximate to the shared client device or to perform a security check of the environment in which the shared client device is located.

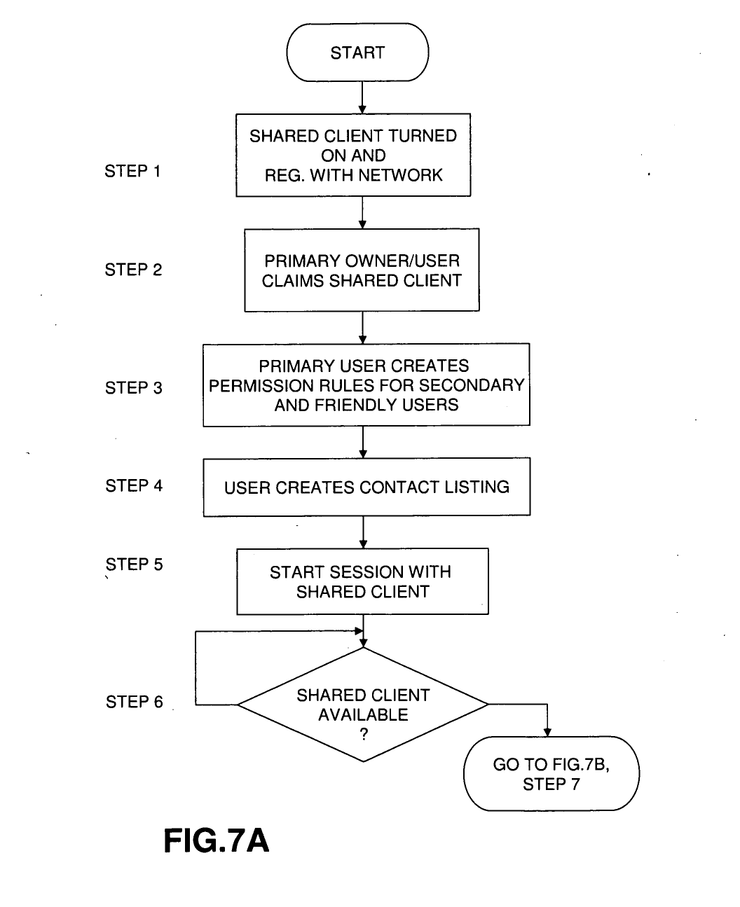

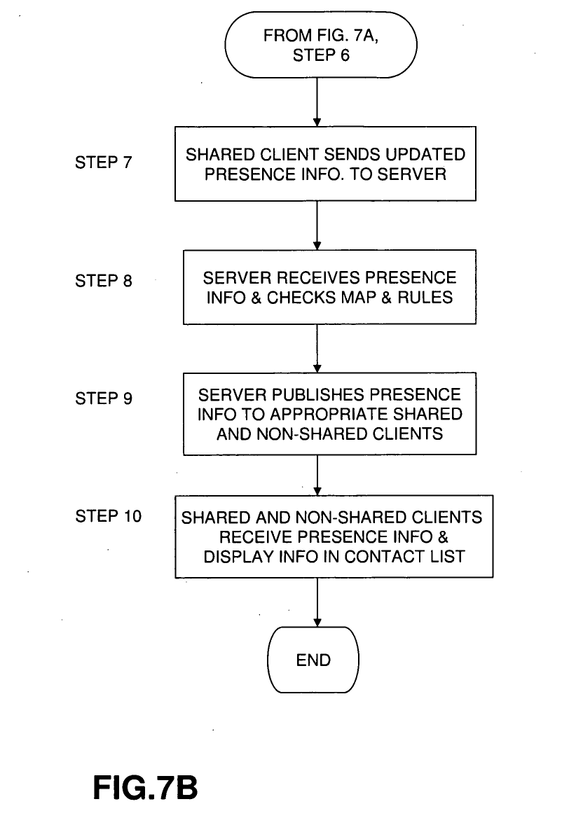

FIGS. 7A and 7B are a logic flow diagram of the method of the preferred embodiment of the invention. In step 1, a shared client device is turned on and either automatically establishes a session with the server 11A in network 10 or is manually prompted by a user to establish the session. In any event, once a communication session is established with server 11A, the shared client device proceeds to register (can send a pre-assigned IP address to the server where it is stored, for instance) with the server 11A as described earlier in some detail with reference to FIG. 4. Once registered with the server 11A, the shared client device is available to be “claimed”, typically by the individual who purchased the device. In step 2, the individual who purchased the shared client device, and who knows the IP address of the shared client device, can use a non-shared client to go to the server 11A to initiate a process to become associated with the shared client device as the primary user of the device. After the primary user is associated with the shared client device, in step 3 the primary user can create permission rules that control one or more secondary and friendly users access to the shared client device. Once the permission rules are created, the secondary users can also initiate a process to become associated with the shared client device in manner similar to the one the primary user employed. In step 4, members of a group who have access to either or both of a shared or non-shared client can create, according to the preferred embodiment of the invention, an ordered, multi-level communication contact list in a directory associated with their shared or non-shared client device. The user can create the contact list with assistance of functionality included in the directory module 53 described with reference to FIG. 5, for instance. Next, in step 6, if the presence information displayed in a user directory indicates that the shared client device is available to enter into a session, the process proceeds to step 7 in FIG. 7B. On the other hand, in the event that the presence information indicates that the device is not available to enter into a communication session, the process simply loops on step 6.

With reference to FIG. 7B, in step 7 the shared client communications device periodically sends a message to the server 11A that includes its updated presence state information. This information can be indicative of the shared client communication device's availability to enter into a communication session and/or it can be indicative of the identify of an individual/user who is currently conducting a session that includes the shared communication device. In this case, the presence message sent to the server 11A can include information indicating that the shared client device is not available to enter into a session. In step 8 the server 11A receives the message from the shared client device that includes the presence state information and employs the presence service 22, of FIG. 1, to examine the relationship map structure 22A and the publication rules 22B in order to determine to which members of the group to publish the presence state information to and to determine how the presence information is displayed in each members directory. In step 9 the server 11A publishes the presence state information to the appropriate members of the group, and in step 10, the communication devices to which the presence state information is published receive the presence state information and display the current state of the shared client communication device in the ordered, multi-level contact list, created in step 4 of FIG. 7A, according to the permission rules created in step 3 of FIG. 7A.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

We claim:

1. A method of displaying presence information in a contact listing associated with a: plurality of shared and non-shared client devices comprising:
at least one of the plurality of the shared client devices generating presence information and sending the presence information to a presence service;
the presence service publishing the presence information to selected ones of the plurality of the shared and non-shared client devices that are members of a group according to a publication map; and
the selected ones of the plurality of the shared and non-shared client devices receiving the published presence information and displaying the presence information in a multi-level contact directory of a least one of the selected ones of the plurality of the shared and non-shared client devices according to a set of permission rules.

2. The method of claim 1 wherein the presence information of one or more of an indication of the availability of a shared or a non-shared client device to enter into a communication session, a device users activity, geographic location of the device user, and the mood of the device user.

3. The method of claim 1 wherein the shared client device is a communication device that includes a client communication application that is accessible to individuals within physical proximity to the communication device.

4. The method of claim 1 wherein the non-shared client device is a communication device that includes a client communication application that is accessible to individuals who have established user profiles in association with the communication application.

5. The method of claim 1 wherein the publication map is comprised of a listing of members of a group.

6. The method of claim 1 wherein the multi-level contract directory can be arbitrarily ordered by a non-shared or shared client device user.

7. The method of claim 1 wherein the permission rules are comprised of instructions used by the multi-level contact directory to display presence information.

8. The method of claim 7 wherein the instructions that comprise the permission rules limit at least one secondary users or at least one friendly user's access to the shared client device.

9. The method of claim 1 wherein the multi-level contact directory is comprised of a first level including a primary or secondary user's contact information and a second level including friendly users contact information.

10. A method of displaying presence information in a contact listing associated with a plurality of non-shared client devices comprising:
at least one of a shared client device generating presence information and sending the presence information to a presence service;
the presence service publishing the presence information to selected ones of the plurality of the non-shared client devices that are members of a group according to a publication map; and
the selected ones of the plurality of the non-shared client devices receiving the published presence information and displaying the presence information in a multi-level contact directory of at least one of the selected ones of the plurality of the non-shared client devices according to a set of permission rules.

11. The method of claim 10 wherein the presence information indicates the availability of a shared client device to enter into a communication session.

12. The method of claim 10 wherein the shared client device is a communication device that includes a client communication application that is accessible to individuals within physical proximity to the communication device.

13. The method of claim 10 wherein the non-shared client device is a communication device that includes a client communication application that is accessible to individuals who have established user profiles in association with the communication application.

14. The method of claim 10 wherein the publication map is comprised of a listing of members of a group.

15. The method of claim 10 wherein the multi-level contract directory can be arbitrarily ordered by a non-shared or shared client device user.

16. The method of claim 10 wherein the permission rules are comprised of instructions used by the multi-level contact directory to display presence information.

17. The method of claim 16 wherein the instructions that comprise the permission rules limit at least one secondary users or at least one friendly user's access to the shared client device.

18. The method of claim 10 wherein the multi-level contact directory is comprised of a first level including a primary or secondary user's contact information and a second level including friendly users contact information.

19. A communication device for displaying presence information, comprising:
a client communication application;
presence functionality; and
a multi-level contact listing for displaying received presence information according to a set of pre-determined permission rules.

20. The communication device of claim 19 wherein the client communication application is one of a shared client application and a non-shared client application.

21. The communication device of claim 19 wherein the presence functionality operates to receive presence information from any one or more members of a group and publish the presence information to selected members of the group according to a publication map.

22. The communication device of claim 21 wherein the publication map is comprised of a listing of members of the group.

23. The communication device of claim 19 wherein the multi-level contract directory can be arbitrarily ordered by a non-shared or shared client device user.

24. The communication device of claim 19 wherein the multi-level contact directory is comprised of a first level including a primary or secondary user's contact information and a second level including friendly users contact information.
